(19) United States
(12) Patent Application Publication
(10) Pub. No.: US 2003/0082315 A1
(43) Pub. Date: May 1, 2003

(54) Highly dimensionally stable honeycomb core and sandwich structures for spacecraft applications

(76) Inventors: Mitchell J. Mehlman, Pleasanton, CA (US); Scott O. Peck, Palo Alto, CA (US)

Correspondence Address: Joyce Kosinski, Loral Space and Communications, Ltd., Suite 303, 655 Deep Valley Drive, Rolling Hills Estates, CA, 90274, US

(21) Appl. No.: 10/001,492

(22) Filed: Oct. 31, 2001

(51) Int. Cl. B32B 3/12

(52) U.S. Cl. 428/16

(57) ABSTRACT

A dimensionally stable honeycomb core and sandwich structure for use in spacecraft applications. The sandwich structure comprises inner and outer faceskins that sandwiches the dimensionally stable honeycomb core. The honeycomb core comprises a fiber and polymer laminate, oriented at a predetermined optimized angle relative to a ribbon direction of the core. Fiber is selected based on strength, modulus and thermal expansion coefficient properties. The polymer is selected based on inherent adhesive properties, coefficient of thermal expansion, moisture absorption, outgassing and its ability to perform in a space environment. The volumetric fraction of fiber and resin and the fiber angular orientation is determined based on the desired system performance, which includes achieving the lowest coefficient of thermal expansion in the plane of the sandwich (ribbon and anti ribbon), as well as through the thickness (z direction). Demanding applications may use ultra-high thermal conductivity fibers where the unidirectional thermal conductivity (K) is greater than 400 W-M/C to minimize the temperature gradients hence achieving a more uniform temperature distribution and lower distortion over the temperature range of interest.

### BACKGROUND

The present invention relates generally to satellites or spacecraft, and more specifically, to a dimensionally stable honeycomb core and sandwich structure for spacecraft applications where extremely high dimensional stability is required to meet performance requirements.

The assignee of the present invention manufactures and deploys spacecraft or satellites into geosynchronous and low earth orbits. The need for higher dimensional accuracy for spacecraft components such as antenna reflector shells, optical benches, deployment mechanisms and bus structures is becoming more critical as the need for higher frequency systems (i.e., Ka band, X band, and higher frequencies) increases.

Traditional sandwich structures use aluminum core, which has a relatively high coefficient of thermal expansion (CTE) and does not produce structures that are dimensionally stable over temperature. Conventional practice includes the use of graphite core material which have a much lower coefficient of thermal expansion than aluminum for reflectors and other dimensionally critical spacecraft components.

However, the use of higher frequency antenna systems requires an order of magnitude improvement in surface accuracy and dimensional stability over temperature. The construction (fiber orientation, thickness, weave construction) and material constituents (type of fiber, resin system, ratio of components) of graphite core material have not been optimized to provide the best possible performance (lowest coefficient of thermal expansion in three dimensions over temperature) in order to minimize distortion and maximize stability.

Accordingly, it is an objective of the present invention to provide for an improved and dimensionally stable honeycomb core for spacecraft applications. It is also an objective of the present invention to provide for an improved sandwich structure for use in spacecraft applications that employs the dimensionally stable honeycomb core. By improving the dimensional stability of the core material, the sandwich structure may be constructed from materials which are less costly (lower modulus) and hence more affordable than the typical materials used in the construction of sandwich structures which used aluminum honeycomb core.

### SUMMARY OF THE INVENTION

To accomplish the above and other objectives, the present invention provides for a dimensionally stable honeycomb core and sandwich structure for use in spacecraft applications. An exemplary dimensionally stable sandwich structure (DSSS) comprises inner and outer faceskins that sandwich a dimensionally stable honeycomb core. The inner and outer faceskins are typically adhesively bonded to the dimensionally stable honeycomb core.

The dimensionally stable honeycomb core is constructed of a fiber and resin laminate, oriented at a specific angle in relation to the core ribbon direction. The fiber is selected based on strength, modulus, coefficient of thermal expansion and cost properties. Demanding applications may utilize ultra-high thermal conductivity fibers where the thermal conductivity (K) is greater than 400 W-M/C to minimize the temperature gradients hence achieving a more uniform temperature distribution and lower distortion over the temperature range of interest.

The resin is selected based on inherent adhesive properties, coefficient of thermal expansion, moisture absorption, mechanical properties, outgassing and its ability to perform successfully in a space environment. The volumetric fraction of fiber and resin and the fiber angular orientation within each ply is determined based on the desired system performance, which includes achieving the lowest coefficient of thermal expansion in the plane of the sandwich (x, y), as well as through the thickness (z). The present invention may be used in any application requiring very low thermal distortion and high dimensional stability over a large range of operating temperatures, typically in the range of −180° C. to +160° C. A practical use of the present invention is for cored sandwich structures requiring high accuracy over temperature such as antenna reflector shells, antenna tower structures, feed horns, hinges, deployment mechanisms and optical bench structures.

The present invention provides for the ability to design core structures by modifying the constituent properties, in concert with an optimization in three directions, so that the best overall system (sandwich) performance is achieved. In this way, the structure of the core can be designed to achieve sandwich structure having a near zero coefficient of thermal expansion.

The present invention utilizes the intrinsic material properties, construction geometry, and analysis software to create an optimized core design, which when combined with faceskin materials of specific known construction, creates an optimized sandwich construction that functions in a spacecraft environment and maintains a high degree of accuracy and dimensional stability, and in particular, maintains an extremely low level of distortion due to thermal gradients compared to traditional materials and construction methods. Materials are selected and construction is designed and optimized to obtain the best system (sandwich) performance in three dimensions such that the optimum performance is achieved without having to sacrifice dimensional stability in the z direction while achieving good dimensional stability in x an y directions.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 illustrates a side view of an exemplary sandwich structure having a dimensionally stable honeycomb core in accordance with the principles of the present invention;

FIG. 2 illustrates a top view of the core of the exemplary sandwich structure shown in FIG. 1;

FIG. 3 illustrates one exemplary embodiment of the structure of the cell wall of the dimensionally stable honeycomb core; and

FIG. 3a illustrates another exemplary embodiment of the structure of the cell wall of the dimensionally stable honeycomb core.

### DETAILED DESCRIPTION

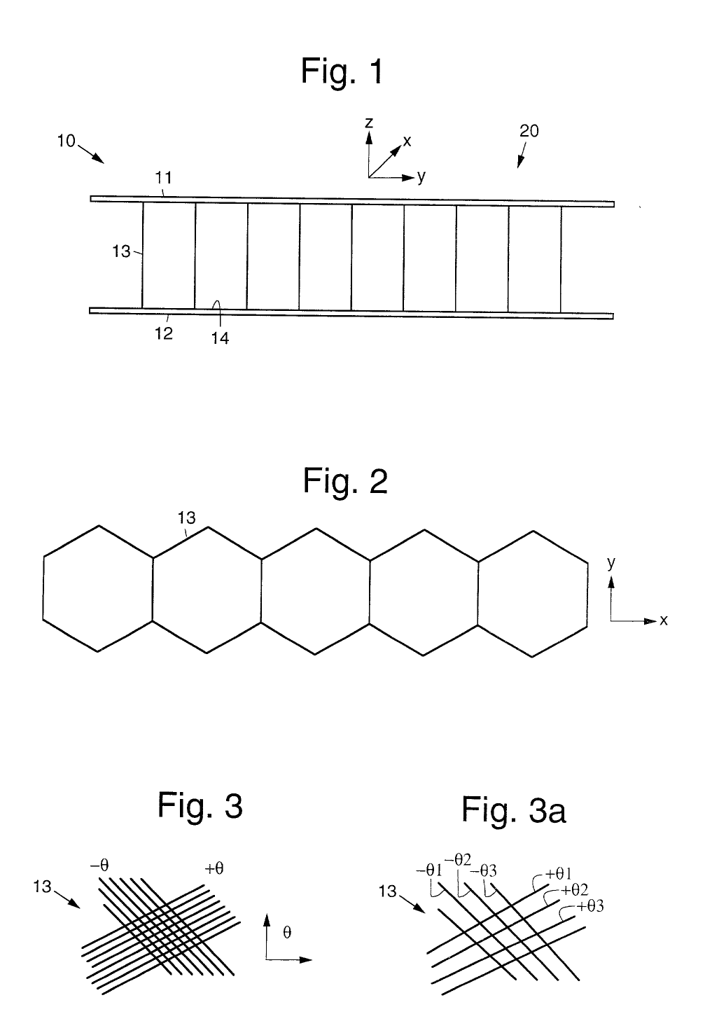

Referring to the drawing figures, FIG. 1 illustrates a side view of an exemplary sandwich structure 10 or system 10 employing a dimensionally stable honeycomb core 13 in accordance with the principles of the present invention. FIG. 2 illustrates a top view of the dimensionally stable honeycomb core 13 used in the exemplary sandwich structure 10 or system 10 shown in FIG. 1.

The sandwich structure 10 or system 10 comprises inner and outer faceskins 11, 12 that sandwich the dimensionally stable honeycomb core 13. The inner and outer faceskins 11, 12 are adhesively bonded to the dimensionally stable honeycomb core 13 using an epoxy or cyanate ester film adhesive (or cocured to the faceskins 11, 12 without film adhesive such that resin in the faceskins 11, 12 forms an adhesive bond during the curing process), a filled low coefficient of thermal expansion (CTE) system in a reticulated or non reticulated configuration, for example. The inner and outer faceskins 11, 12 may me made of a suitable material such as traxially woven aramid fibers with a cyanate ester matrix or orthotropically woven graphite fibers with an epoxy matrix, for example.

The dimensionally stable honeycomb core 13 preferably has a hexagonally-shaped cross section. The dimensionally stable honeycomb core 13 is preferably a fiber and resin laminate of, or more plies or layers, oriented at a predetermined specific angle in relation to the ribbon direction of the core 13. FIG. 3 illustrates one exemplary embodiment of the structure of a cell wall of the dimensionally stable honeycomb core 13. FIG. 3a illustrates another exemplary embodiment of the structure of the cell wall of the dimensionally stable honeycomb core having multiple plies and angles.

The coefficient of thermal expansion of the material comprising the core 13 is optimized in three dimensions. The fiber volume fraction is determined by optimizing the selection of individual constituents such that the properties can be tailored to achieve the desired low distortion laminate in the range of a producible material which can be processed by standard manufacturing methods. This is achieved by variation in the fiber to resin ratio of the raw material and carefully controlling the process to insure low variation in the preimpregated raw materials the laminated core and the faceskins. Ply orientation (FIG. 3) is also determined by optimizing fiber angle and stacking sequence in relation to the system coefficient of thermal expansion. This may be achieved by laminating the layers in a prescribed manner with regard to angle of orientation in reference to a datum as determined by the optimization, for example ply 1 at 30 digress. ply 2 at 45 degrees, ply 3 at negative 45 degrees and ply 4 at negative 30 degrees to produce a symmetric and balanced laminate to resist and/or balance internal stresses which lead to distortion.

The fiber is selected based on strength, modulus and coefficient of thermal expansion properties. Typical ranges of values for strength, modulus and coefficient of thermal expansion properties are as follows: strength from 100 Ksi to 1000 Ksi, modulus from 30 Msi to 130 Msi, CTE from 2 ppm/C to −2 ppm/C.

The resin is selected based on inherent adhesive properties, coefficient of thermal expansion, moisture absorption, outgassing and its ability to perform successfully in a space environment. Exemplary resins include epoxies and poly cyanates, for example The volumetric fraction of fiber and resin and the fiber angular orientation is determined based on the desired system performance, which includes achieving the lowest coefficient of thermal expansion in the plane of the sandwich, as well as through the thickness. This is determined by finite element analysis.

Demanding applications may utilize ultra-high thermal conductivity fibers where the coefficient of thermal expansion (K) is greater than 400 W-M/C to minimize temperature gradients. This achieves a dimensionally stable honeycomb core 13 having a more uniform temperature distribution and lower distortion over the temperature range of interest.

The present invention thus uses the intrinsic material properties, construction geometry, and analysis software to create an optimized core design, which when combined with faceskin materials of specific known construction, creates an optimized sandwich construction that functions in a spacecraft environment and maintains a high degree of accuracy and dimensional stability. Materials are selected and construction is designed and optimized to obtain the best system (sandwich) performance in three dimensions.

Thus, a dimensionally stable honeycomb core and sandwich structure for use in spacecraft applications has been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A dimensionally stable honeycomb core for use in spacecraft applications, comprising:
a fiber and resin laminate having internal plies, oriented at one or more predetermined angles relative to a ribbon direction of the core.

2. The honeycomb core recited in claim I which has a hexagonally-shaped cross section

3. The honeycomb core recited in claim 1 whose coefficient of thermal expansion is optimized in three dimensions by finite element analysis.

4. The honeycomb core recited in claim 1 wherein the fiber volume fraction is determined by optimizing the coefficient of thermal expansion in x, y and z directions.

5. The honeycomb core recited in claim 1 wherein ply orientation is determined by optimizing the coefficient of thermal expansion in x, y and z directions.

6. The honeycomb core recited in claim 1 wherein the volumetric fraction of fiber and resin and the fiber angular orientation is determined based on the desired system performance to achieve the lowest coefficient of thermal expansion in the plane of the sandwich (x and y) and through the thickness (z).

7. The honeycomb core recited in claim 1 wherein the dimensionally stable honeycomb core 13 comprises ultra-high thermal conductivity fibers having a thermal conductivity greater than 400 W-M/C to minimize temperature gradients.

8. A sandwich structure for use in spacecraft applications, comprising:
inner and outer faceskins; and
a dimensionally stable honeycomb core disposed between the inner and outer faceskins, which honeycomb core comprises a fiber and resin laminate, oriented at a predetermined angle relative to a ribbon direction of the core.

9. The structure recited in claim 8 wherein the inner and outer faceskins are adhesively bonded to the dimensionally stable honeycomb core.

10. The structure recited in claim 8 wherein the inner and outer faceskins are cocured without film adhesive to the dimensionally stable honeycomb core.

11. The structure recited in claim 8 wherein the inner and outer faceskins are adhesively bonded to the dimensionally stable honeycomb core using a low coefficient of thermal expansion film adhesive.

12. The structure recited in claim 11 wherein the low coefficient of thermal expansion film adhesive comprises a resin film and low coefficient of thermal expansion filler.

13. The structure recited in claim 12 wherein the low coefficient of thermal expansion filler comprises carbon fibers.

14. The structure recited in claim 12 wherein the low coefficient of thermal expansion filler comprises carbon particulates.

15. The structure recited in claim 11 wherein the low coefficient of thermal expansion film adhesive comprises a resin film and low coefficient of thermal expansion filler, which film adhesive is reticulated to core nodes.

16. The structure recited in claim 8 wherein the inner and outer faceskins comprise fiber and resin materials optimized to provide dimensional stability.

17. The structure recited in claim 16 wherein the fiber material is selected from a group of materials consisting of graphite, carbon, glass, ceramic, and organic materials.

18. The structure recited in claim 16 wherein the resin material is selected from a group of polymeric materials consisting of thermosetting resins, epoxies, cyanates, and engineered thermoplastics

19. The structure recited in claim 16 wherein the engineered thermoplastic material is selected from a group consisting of poly ether imides, poly etherether ketones, and mixtures of such materials.

20. The structure recited in claim 8 wherein the honeycomb core has a fiber volume fraction that is determined by optimizing the coefficient of thermal expansion in x, y and z dimensions.

21. The structure recited in claim 8 wherein the honeycomb core has a ply orientation is determined by optimizing the coefficient of thermal expansion in x, y and z dimensions.

22. The structure recited in claim 8 wherein the honeycomb core has a volumetric fraction of fiber and resin and fiber angular orientation that is determined based on a desired system performance to achieve the lowest coefficient of thermal expansion in the plane of the sandwich and through the thickness.

23. The structure recited in claim 8 wherein the honeycomb core comprises ultra-high thermal conductivity fibers having a thermal conductivity greater than 400 W-M/C to minimize temperature gradients.
